(19) United States
(12) Patent Application Publication
(10) Pub. No.: US 2022/0356894 A1
(43) Pub. Date: Nov. 10, 2022

(54) Tenon-joints-attached Frames for Aluminum Furniture

(71) Applicant: Nattapong Anekadhana, Bangkok (TH)

(72) Inventor: Nattapong Anekadhana, Bangkok (TH)

(21) Appl. No.: 17/336,042

(22) Filed: Jun. 1, 2021

(30) Foreign Application Priority Data
May 6, 2021 (TH) 2101002698

(51) Int. Cl. F16B 12/32

(52) U.S. Cl. CPC F16B 12/32; F16B 2200/30; A47B 2230/0081

(57) ABSTRACT

Tenon-joints-attached Frames for Aluminum Furniture has features that include the male tenon and the female tenon which once fixed together and assembled to Aluminum Furniture Frame 1 and Aluminum Furniture Frame 2 in order. Once assembled, the male tenon and the female tenon will hide inside the grooves aforementioned where the male tenon which is characterized by a wide area and a rectangular body works by being inserted into Aluminum Furniture Frame 1 to fix them together. Next to the wide area is constructed a narrow area that is characterized by being a sheet that is perpendicular to the wide area. The walls of the narrow area will have at least one extrusion that works by inserting the extrusions into the intrusions of the female tenon. The female tenon, which is characterized by a rectangular body, works by being inserted into Aluminum Furniture Frame 2 to fix them together. One position on the rectangular body will have at least one intrusion to facilitate the fitting with the extrusions from the male tenon wherein the male tenon and the female tenon will be fixed together in a vertical direction.

### BRIEF DESCRIPTION

### Field of Invention

The present invention relates to tenon-joints-attached Frames for Aluminum Furniture

### Background of Relevant Arts or Sciences

In old inventions, aluminum furniture is fixed together by nuts and bolts or by riveting during a factory's assemblage. This takes up a lot of space during transportation and storage, or if parts are to be assembled on-site, many equipment, handyman tools, and adeptness in installment will be required.

Referring to the Chinese patent request number CN102635614A: structural binding via directly attaching the frames of aluminum furniture cabinet's body. Fully assembled aluminum furniture manufactured by directly attaching frames comprises of the following features: Frame I (1) which has vertical groove and Frame II which is horizontal in which Frame I and Frame II are attached via a connecting part. The directly attached structural frame of aluminum furniture cabinet's body in full can be used for the direct attachment of frame of the vertical middle sheet, side sheets, upper sheets, bottom sheet or laminate and can be used to manufacture full aluminum furniture which has the drawbacks of needing to use nuts and bolts to adhere the parts which wastes time and requires professional equipment.

### SUMMARY

Tenon-joints-attached Frames for Aluminum Furniture have features including the male tenon and the female tenon which are fixed together then assembled to the groove in Aluminum Furniture Frame 1 and the groove in Aluminum Furniture Frame 2, in that order of assemblage. The male tenon and female tenon will be hiding within the grooves aforementioned. Wherein the male tenon, which has the feature of a wide area and a rectangular body, will slide and fit into Aluminum Furniture Frame 1. Next to the wide area is constructed a narrow area characterized by being a sheet perpendicular to the wide area. The wall of the narrow area will have at least one extrusion which will slide into the hollow of the female tenon. The female tenon which has a rectangular body works by being inserted into the Aluminum Furniture Frame 2 to connect them together. At one part of the rectangular body of the female tenon exists at least one intrusion to facilitate the joining of male and female tenons where the male and female tenons will move to meet each other in the vertical direction.

This invention has the purpose to create a tenon-joints-attached aluminum furniture that can be functioned by the user. The user can assemble the furniture by himself without the use of any other external equipment including nuts and bolts, screws, etc. And when the assemblage is done, the male and female tenons will be neatly hiding in the groove of the aluminum furniture.

### BRIEF DESCRIPTIONS OF THE DRAWINGS

FIG. 1 shows the components of the tenon-joints-attached frames for aluminum furniture according to this invention.

FIG. 2 shows the components of the male tenon (10) and the female tenon (20) which are fixed together according to this invention.

FIG. 3 shows the component of the male tenon (10) and female tenon (20) which are fixed together and assembled to Aluminum Furniture Frame 1 (31) and Aluminum Furniture Frame 2 (32), in that order, according to this invention.

### DETAILED DESCRIPTION

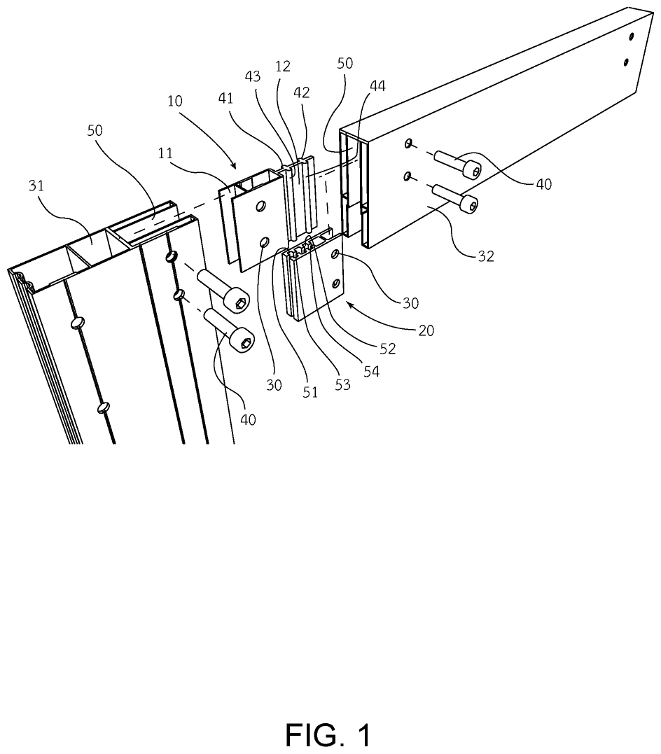

FIG. 1 shows the components of tenon-joints-attached frame for aluminum furniture which comprise of:

Male Tenon (10) characterized by a wide surface (11) and characterized by a rectangular body which works by inserting itself into the Aluminum Furniture Frame 1(31) to be assembled together. Next to the wide area (11) is constructed a narrow area (12) which has the characteristic of being perpendicular to the wide area. (11) The wall of the narrow area (12) will have at least 2 places of extrusion which works by inserting themselves into the intrusion of the female tenon. (20) In which this invention has been designed to have extrusion 1 (41), extrusion 2 (42), extrusion 3 (43), and extrusion 4 (44), etc.

In which the extrusions root from the top ceiling of the male tenon (10) downward to the bottom floor of the male tenon. (10)

The female tenon (20), which is characterized by a rectangular body, works by inserting itself into Aluminum Furniture Frame 2 (32), to fix them together. At one position of the rectangular body is at least one intrusion to facilitate the fixing together of the male tenon to the female tenon. (10) In which this invention has been designed to have intrusion 1 (51), intrusion 2 (52), intrusion 3 (53), and intrusion 4(54), etc.

Wherein the male tenon (10) and the female tenon (20) will move to meet each other in the vertical plane.

Wherein the intrusion will root at the ceiling of the female tenon (20) and extend downwards to the bottom of the female tenon (20).

Wherein the male tenon (10) and the female tenon (20) will either be equal or not equal in heights.

Wherein the male tenon (10) and female tenon (20) will either be equal or not equal in lengths.

One position on the body of the male tenon (10) and one position on the body of the female tenon (20) will have holes for nuts and bolts (30). At least one position is meant for the insertion of nuts and bolts (40) to adhere Aluminum Furniture Frame 1 (31) and Aluminum Furniture Frame 2 (32) in that order.

As for the body of the male tenon (10) and the body of the female tenon (20) will have geometric shapes or arbitrary shapes defined by the perimeter to aid the fixing together of the elements, Aluminum Furniture Frame 1 (31), and Aluminum Furniture Frame 2 (32) in that order. In the character of fixing together via vertical or horizontal insertion to become the structural mesh of aluminum furniture where the male tenon (10) and female tenon (20) will be in the same axis as Aluminum Furniture Frame 1 (31) and Aluminum Furniture Frame 2 (32) or otherwise, the male tenon (10) and female tenon (20) will not align on the same axis as Aluminum Furniture Frame 1 (31) and Aluminum Furniture Frame 2 (32).

The body of the male tenon (10) and the body of the female tenon (20) will be smaller than the grooves (50) of Aluminum Furniture Frame 1 (31) and Aluminum Furniture Frame 2 (32) in that order. When assembled together, the male tenon (10) and the female tenon (20) will hide under the groove (50) aforementioned.

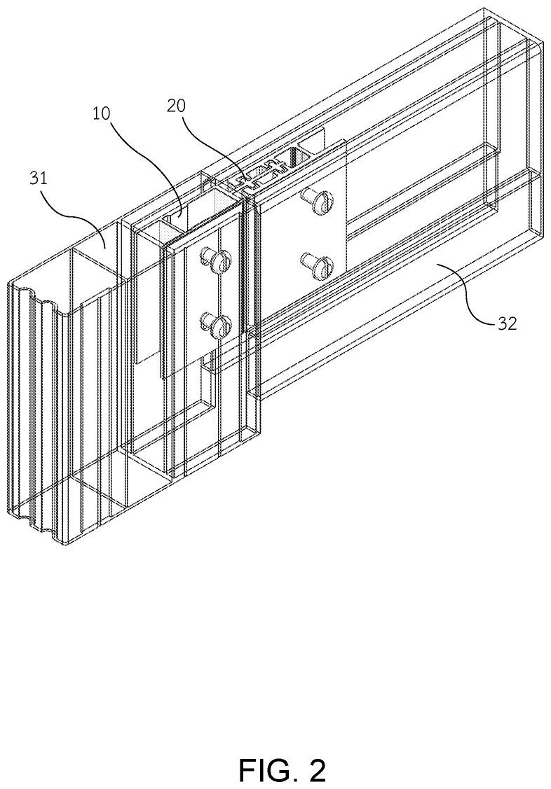

FIG. 2 shows the components of male tenon (10) and the female tenon (20) when fixed together.

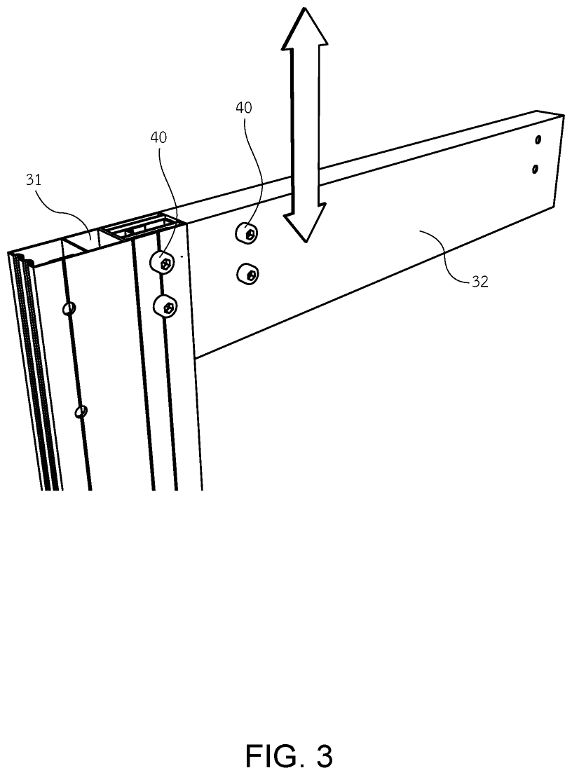

FIG. 3 (refer to FIG. 1 for information) shows the components of the male tenon (10) and the female tenon (20) that are fixed together and assembled to Aluminum Furniture Frame 1 (31) and Aluminum Furniture Frame 2 (32) in that order so that when assembled together once assembled, the male tenon (10) and the female tenon (20) will hide within the groove (50) aforementioned.

1. Tenon-joints-attached Frames for Aluminum Furniture have features including the male tenon (10) and the female tenon (20) which are fixed together then assembled to the groove in Aluminum Furniture Frame 1 (31) and the groove in Aluminum Furniture Frame 2 (32) in that order of assemblage. The male tenon (10) and female tenon (20) will be hiding within the grooves (50) aforementioned.
With the special features that:
The male tenon (10) which has the feature of a wide area (11) and a feature of a rectangular body which. The part works by being inserted into the Aluminum Furniture Frame 1 (31) to fix the two together. Next to the wide area (11) is constructed a narrow area (12) which has the feature of perpendicularity to the wide area (11) The wall of the narrow area (12) will have at least 2 extrusions to fit into the intrusion of the female tenon (20).
The female tenon (20) which has a rectangular body works by intruding itself into the Aluminum Furniture Frame 2 (32) to fix them together. One position of the body part that is rectangular contains at least one intrusion to facilitate the fixing of the male tenon (10) to the female tenon.
Where the male tenon (10) and female tenon (20) will be fixed together in a vertical direction.

2. The tenon-joints-attached Frames for Aluminum Furniture according to claim 1 in which the extruded parts of the male tenon (10) consist of extrusion 1(41), extrusion 2 (42), extrusion 3 (43), and extrusion 4 (44), etc.

3. The tenon-joints-attached Frames for Aluminum Furniture according to claim 1 in which the intruded parts of the female tenon (20) consist of intrusion 1 (51) intrusion 2 (52) intrusion 3 (53), and intrusion 4 (54).

4. The tenon-joints-attached Frames for Aluminum Furniture according to claim 1 in which the extruded part roots at the ceiling of the male tenon (10) and extends downwards to the bottom of the male tenon (10).

5. The tenon-joints-attached Frames for Aluminum Furniture according to claim 1 in which the intrusion will form at the top ceiling of the female tenon (20) and extend to the bottom floor of the female tenon (20).

6. The tenon-joints-attached Frames for Aluminum Furniture according to claim 1 in which the male tenon (10) and female tenon (20) can either have equal or unequal heights.

7. The tenon-joints-attached Frames for Aluminum Furniture according to claim 1 in which the male tenon (10) and female tenon (20) can either have equal or unequal lengths.

8. The tenon-joints-attached Frames for Aluminum Furniture according to claim 1 in which one of the positions on the male tenon (10) and one of the positions on the female tenon (20) will have holes for nuts and bolts insertion (30). At least one of the positions has to be inserted with nuts and bolts (40) to fit itself to Aluminum Furniture Frame 1 (31) and Aluminum Furniture Frame 2 (32), in that order.

9. The tenon-joints-attached Frames for Aluminum Furniture according to claim 1 in which the body of the male tenon (10) and the body of the female tenon (20) contain geometric shape or arbitrary shape defined by the perimeter to have a mechanism to be fitted to Aluminum Furniture Frame 1 (31) and Aluminum Furniture Frame 2 (32) in that order, where the fitting together process is done vertically or horizontally to become a structural mesh where the male tenon (10) and the female tenon (20 will be on the same axis as Aluminum Furniture Frame 1 (31) and Aluminum Furniture Frame 2 (32) or where the male tenon (10) and female tenon (20) will not be aligned on the same axis with Aluminum Furniture Frame 1 (31) and Aluminum Furniture Frame 2 (32).

10. The tenon-joints-attached Frames for Aluminum Furniture according to claim 1 in which the body of the male tenon (10) and the body of the female tenon (20) will be smaller than the groove (50) of Aluminum Furniture Frame 1 (31) and Aluminum Furniture Frame 2 (32) in that order when assembled together, the male tenon (10) and female tenon (20) will hide within the grooves (50) aforementioned.
